(19) United States
(12) Patent Application Publication
(10) Pub. No.: US 2023/0016334 A1
(43) Pub. Date: Jan. 19, 2023

(54) SYSTEMS AND METHODS FOR CARBON DIOXIDE SEQUESTRATION INJECTION

(71) Applicant: TerraCOH Inc., Bloomington, MN (US)

(72) Inventor: Larry G. Chorn, Golden, CO (US)

(21) Appl. No.: 17/863,096

(22) Filed: Jul. 12, 2022

Related U.S. Application Data
(60) Provisional application No. 63/221,387, filed on Jul. 13, 2021.

(51) Int. Cl. E21B 43/16; F24T 10/20

(52) U.S. Cl. CPC E21B 43/164; F24T 10/20

(57) ABSTRACT

A method comprises introducing a sequestration fluid through one or more injection wells into an underground reservoir containing at least one native fluid. Each injection well includes one or more injection well reservoir openings through which the sequestration fluid flows from the injection well into the underground reservoir. The method further comprises simultaneously or substantially simultaneously withdrawing a portion of the at least one native fluid through one or more withdrawal wells. Each injection well includes one or more withdrawal well reservoir openings through which the portion of the at least one native fluid flows from the underground reservoir into the withdrawal well. The one or more withdrawal well reservoir openings are proximate to the one or more injection well reservoir openings.

### CROSS-REFERENCE TO RELATED APPLICATION

This application claims the benefit of priority to U.S. Provisional Patent Application Ser. No. 63/221,387 entitled “SYSTEMS AND METHODS FOR CARBON DIOXIDE SEQUESTRATION INJECTION,” filed Jul. 13, 2021, the disclosure of which is incorporated by reference herein in its entirety.

### BACKGROUND

In light of global climate change and in response to an increased desire to reduce dependence on foreign oil supplies, renewable energy systems, such as wind, solar and geothermal-based systems are being increasingly researched and developed. In addition, in response to rapidly increasing carbon dioxide levels in the atmosphere, systems for removal, usage, and, optionally, sequestration of carbon dioxide are also being actively researched. However, many renewable systems have only limited potential due to, for example, high costs, overall process inefficiencies, and possible adverse environmental impact.

### SUMMARY OF THE DISCLOSURE

The present disclosure describes systems and methods for improving the injectivity of a sequestration fluid into a reservoir. For example, the present disclosure describes a system wherein the sequestration fluid is injected into a brine aquifer through an injection well. The system also provides for managed withdrawal of brine from a production well that is proximate to the injection well, wherein the withdrawn brine provides space and reduced pressure within the aquifer for the sequestration fluid to be injected, which allows the sequestration fluid to be injected at a higher rate than could be injected if the brine was not withdrawn from the aquifer proximate to the injection well. This allows for fewer injection wells and reduces the potential for inadvertently fracturing the rock formation of the aquifer or creating inadvertent seismic events.

In an example, the withdrawal wells that provide for withdrawal of the brine comprise perforated deviated or highly deviated wells, which can provide for substantially higher brine withdrawal flow rate compared to a similar vertical well for a given bottom hole pressure. Therefore, deviated or highly deviated withdrawal wells can mitigate breakdown of the rock matrix and prevent sand production into the wellbore by allowing for lower differential drawdown pressure across the well perforations while still allowing for high brine withdrawal rates.

The present disclosure also describes a system wherein the one or more injection wells that feed the sequestration fluid into the reservoir are perforated deviated or highly deviated wells rather than vertical injection wells. Similar to the deviated or highly deviated brine withdrawal wells described above, the use of deviated or highly deviated injection wells provides for a reduced pressure of the injected sequestration fluid as it exits the injection well compared to a vertical injection well that feeds the sequestration fluid at the same flow rate. In other words, the deviated or highly deviated injection wells can inject the sequestration fluid into the reservoir at a higher injection rate when compared to vertical injection wells at the same operating pressure. This allows the sequestration fluid to be injected into the reservoir at a higher injection rate while still keeping the pressure below that which would cause failure of the rock matrix, i.e., below the matrix's fracturing pressure. In short, the deviated or highly deviated wells allow for an unfractured rock matrix while still achieving a higher specified injection rate, which reduces the number of injection wells required to match the CO₂ production rate of a CO₂ emitter.

### BRIEF DESCRIPTION OF THE DRAWING

The drawing illustrates generally, by way of example, but not by way of limitation, various embodiments discussed in the present document.

FIG. 1 is simplified schematic diagram of a first example energy generation system.

FIG. 2 is a simplified schematic diagram of a second example energy generation system.

FIG. 3 is a simplified schematic diagram of a third example energy generation system.

FIG. 4 is a simplified schematic diagram of a fourth example energy generation system.

FIGS. 5A-5D are simplified schematic diagrams of an example system for withdrawing native fluid while injecting a sequestration fluid into a reservoir at various stages during the sequestration process.

FIG. 6 is a schematic diagram of an example deviated injection well for use with any one of the systems of FIGS. 1-5.

FIG. 7 is a schematic diagram of an example deviated withdrawal well for use with the native fluid withdrawal system of FIGS. 5A-5D.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment”, “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also all individual concentrations (e.g., 0.5%, 1%, 2%, 3%, 3.2%, 4%, etc.) and sub-ranges (e.g., 0.1% to 0.5%, 1.1% to 2.2%, and 3.3% to 4.4%) within the indicated range. The statement “about X to Y” has the same meaning as “about X to about Y,” unless indicated otherwise. The statement “about X or Y” has the same meaning as “about X or about Y.” Likewise, the statement “about X, Y, or Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000.1” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Definitions

The terms “subterranean,” “subsurface,” or “underground,” as used herein, can refer to locations and/or geological formations beneath the Earth's surface.

The term “rock,” as used herein, can refer to a relatively hard, naturally formed mineral, collection of minerals, or petrified matter. Various types of rocks have been identified on Earth, to include, for example, igneous, metamorphic, sedimentary, and the like. A rock can erode or be subject to mass wasting to become sediment and/or soil proximate to or at a distance of many miles from its original location.

The term “rock formation,” as used herein, can refer to a collection of one or more rocks in a particular overall geometric arrangement.

The term “sediment,” as used herein, can refer to a granular material eroded by forces of nature, but not yet to the point of becoming “soil.” Sediment may be found on or within the Earth's crust. Sediment is commonly unconsolidated, although “partially consolidated sediments” are often referred to simply as “sediments” and are therefore considered to be included within the definition of sediment used herein.

The term “sediment formation,” as used herein, can refer to a collection of one type of sediment or of a plurality of types of sediments in a particular overall geometric arrangement.

The term “soil,” as used herein, can refer to a granular material comprising a biologically active, porous medium. Soil is found on, or as part of, the uppermost layer of the Earth's crust and evolves through weathering of solid materials, such as consolidated rocks, sediments, glacial tills, volcanic ash, and organic matter. Although often used interchangeably with the term “dirt,” dirt is technically not biologically active.

The term “geological formation,” as used herein, can refer to a collection of one or more of: one or more rocks, one or more sediments, and one or more soils. in a particular overall geometric arrangement. In other words, a “geological formation” can be formed by the combination of one or more rock formations, one or more sediment formations, and/or one or more soils.

The term “reservoir,” “storage rock formation,” or “storage sediment formation,” as used herein, can refer to a formation comprising one or more of rock, sediment, and soil that can be capable of receiving and storing an amount of fluid substantially “permanently” as that term is understood in the geological arts.

The term “fluid,” as used herein, can refer to a liquid, gas, or combination thereof, or a fluid that exists above the critical point, e.g., a supercritical fluid. A fluid is capable of flowing, expanding, and accommodating a shape of its physical surroundings. A fluid can comprise a native fluid, a working fluid, or combinations thereof. Examples of fluids include, for example, air, water, brine (e.g., salty water), hydrocarbon liquids (such as those corresponding to oil or other petroleum liquids), hydrocarbon gases (such as natural gas, methane, and other lower order hydrocarbon gases), CO₂, magma, noble gases, or any combination thereof.

The term “native fluid,” as used herein, can refer to a fluid which is resident in a rock formation or sediment formation prior to the implementation of the systems or methods of the present disclosure. A native fluid includes, but is not limited to, water, brine, saline water, oil, natural gas, hydrocarbons (e.g., methane, natural gas, oil), and combinations thereof. Carbon dioxide can also be previously present in the rock or sediment formation and thus constitute a native fluid in this case.

The term “sequestration,” as used herein, can refer to permanent or semi-permanent storage of a fluid that is not native in an underground reservoir that is not native to the rock formation or sediment formation of the reservoir. Some examples of reservoirs in which one or more fluids can be sequestered include, but are not limited to, a depleted oil or gas reservoir, a saline aquifer, or a deep un-minable coal bed.

The term “sequestration fluid,” as used herein, can refer to a fluid that is stored in a reservoir during sequestration. The most common sequestration fluid is carbon dioxide (CO₂) that is to be sequestered in a sequestration reservoir, such as CO₂ that has been produced by a CO₂ emitter (also referred to simply as an “emitter”), such as a cement factory, a fuel production facility, an electricity generation plant, and the like. Other examples of sequestration fluids include, but are not limited to, mixtures of two or more of carbon dioxide, hydrogen sulfide, and methane (CO₂—H₂S—CH₄ mixtures), nitrogen oxide (NOₓ) gases, saline brines, oil-field produced water or water-based solutions, chemically-contaminated wastewaters that are considered unsuitable for surface disposal, and the like. In some examples, a portion of the sequestration fluid can be used as a working fluid, such as the working fluid for the recovery of geothermal energy from the reservoir.

The term “working fluid,” as used herein, can refer to a fluid that is used by the systems or methods of the present disclosure for some purpose. A working fluid can undergo a phase change from a gas to a liquid (energy source), a liquid to gas (refrigerant), or can become part of a solution (e.g., by dissolving into another fluid such as a native fluid). A “working fluid” in a machine or in a closed loop system can be the heated and/or pressurized gas or liquid that is used for operation of the machine or system, such as by actuating the machine or for transferring energy to or from the system.

The term “CO₂-based plume” (or the shortened form “CO₂ plume”) as used herein, can refer to a large-scale (e.g., meters to several kilometers to tens of kilometers across) formation of a CO₂-based fluid present within subsurface pore spaces in a subterraneous reservoir. Within a CO₂-based plume, a significant percentage of fluid in the plume formation is CO₂. The CO₂-based plume can include other fluids, such as native methane or other hydrocarbons, which can be collected and carried by the CO₂-based plume as it travels through a reservoir. For example, a CO₂-based plume can include a substantial percentage (e.g., as much as 20 wt. %) methane that has been desorbed from a saline aquifer (as described in more detail below). A CO₂-based plume can also include a substantial portion of native hydrocarbons (e.g., up to 90 wt. % hydrocarbons or more) and can still be considered a “CO₂-based plume” within the meaning of the present disclosure. A CO₂-based plume can contain a substantial portion, e.g., as much as 70% by volume, or more, of a native fluid such as brine or hydrocarbons extracted from a reservoir. The brine or other native fluid can be immobile or only minimally mobile and, therefore, generally considered in the art to be residually trapped.

The term “brine solution” (also referred to simply as “brine”), as used herein, refers to an aqueous solution comprising a relatively high concentration of dissolved salts, e.g., dissolved ions of salt compounds, primarily dissolved chloride ions (Cl⁻) and sodium ions (Na⁺) from sodium chloride (NaCl), but other ions can be present in other amounts, including, but not limited to, sulfate ions (SO₄²⁻), magnesium ions (Mg²⁺), calcium ions (Ca²⁺), potassium ions (K⁺), carbonate ions (CO₃²⁻), bicarbonate ions (HCO₃⁻), bromide ions (Br⁻), tetrahydroxyborate ions (B(OH)₄⁻), strontium ions (Sr²⁺), and fluoride ions (F⁻). Brine solutions typically have a salinity of at least about 3% (e.g., at least about 30 g salts per kg of the brine solution), although solutions with salinities lower than 3% can still be used in the systems and methods described herein. Brine solutions can also have salinities up to full saturation of the water (e.g., around 26-28% or about 260-280 g salt per kg of solution).

The terms “geothermal heat flow,” “geothermal heat,” or “geothermal energy,” as used herein, can refer to any kind of heat transfer in the subsurface and can include one or more of conductive heat transfer, advective heat transfer (also referred to as convective heat transfer), and radiative heat transfer (although radiative heat transfer can typically be negligible in the subsurface). A “low” heat flow generally can be considered to be less than about 50 milliwatts per square meter. A “moderate” heat flow generally can be considered to be at least about 50 to about 80 milliwatts per square meter. A “high” heat flow generally can be considered to be greater than 80 milliwatts per square meter.

The term “injection well,” as used herein, can refer to a well or borehole, which can be cased (e.g., lined) or uncased, and which can contain one or more pipes through which a fluid can flow (typically in a downward direction) for purposes of releasing that fluid into the subsurface at some depth. Multiple injection wells, e.g., two or more, for supplying a sequestration fluid to one or more injection areas within a reservoir are also included within this definition.

The term “production well,” as used herein, can refer to a well or borehole, which can be cased (e.g., lined) or uncased, and which can contain one or more pipes through which a fluid can flow (typically in an upward direction) for purposes of bringing fluids up from the subsurface up to the Earth's surface or near the surface. A production well can exist in the same borehole as an injection well. Multiple production wells, e.g., two or more, for drawing fluid from one or more different locations within the reservoir, i.e., to draw fluid from one or more different areas of the plume, are also included within this definition.

The term “withdrawal well,” as used herein, can refer to a production well that is configured to withdraw a fluid, such as a native fluid, for example brine, in order to improve injectivity of a sequestration fluid or working fluid into the reservoir. In some examples, the withdrawal well can withdraw the fluid from a location that is proximate to (e.g., within a specified distance from) one or more injection wells to create pore volume space for the sequestration fluid or working fluid and to manage the bottom hole pressure at the one or more injection wells.

The term “injectivity” as used herein, refers to the amount of a sequestration fluid or working fluid that can be injected into a sequestration reservoir at a specified bottom hole pressure (bhp) (i.e., the absolute pressure of the fluid at the injection point in the well). In an example, injectivity is a function of the bhp, the reservoir pressure, the rock matrix permeability and any damage (i.e., plugging of permeability) caused by the drilling process or the migration of fines in the pore space of the rock matrix. Raising the pressure differential, i.e., by raising the bhp, will increase the amount of fluid able to enter the rock matrix. However, there is an upper limit on how much pressure the rock matrix can sustain before the rock matrix cracks, fractures, or otherwise fails.

### Fluid Sequestration System

Geological sequestration of a sequestration fluid, such as carbon dioxide gas (CO₂), is a process by which the sequestration fluid is injected into a sequestration reservoir such that the sequestration fluid can be stored in the sequestration reservoir on a permanent or substantially permanent basis. As noted above, the most common sequestration fluid is CO₂ because of its contribution to climate change as a greenhouse gas. Therefore, the remainder of the present disclosure will refer to the sequestration fluid as CO₂. However, those having skill in the art will appreciate that other fluids can be sequestered within the reservoir in place of or in addition to CO₂, including, but not limited to, CO₂—H₂S—CH₄ mixtures, NOₓ gases, saline brines, oil-field produced water or water-based solutions, chemically-contaminated wastewaters considered unsuitable for surface disposal, and the like.

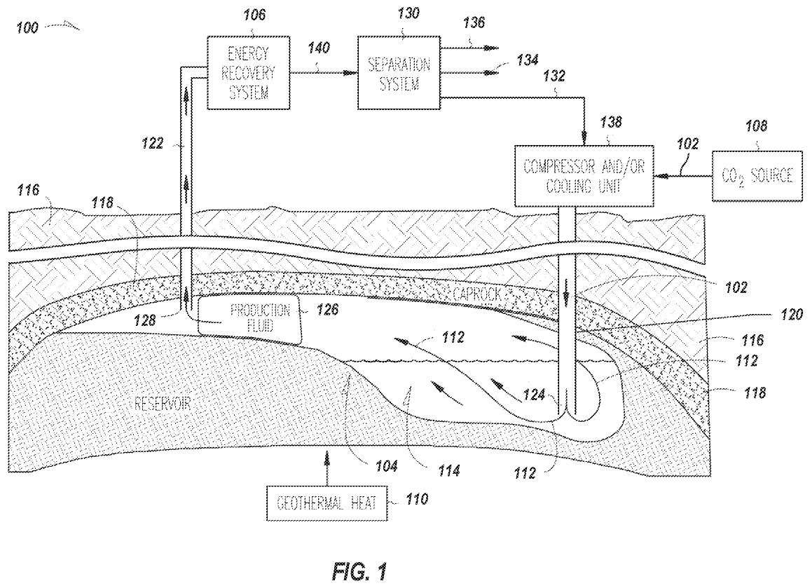

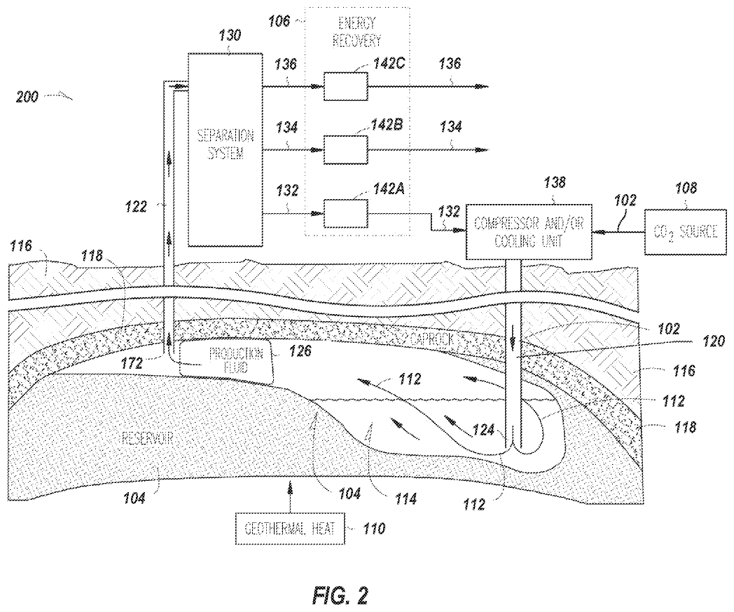

FIGS. 1 and 2 show two examples of generic systems 100, 200 that can include sequestration of CO₂ 102 into a sequestration reservoir 104. As described in more detail below, in an example, a portion of the CO₂ 102 can be produced from the reservoir 104 and used as a working fluid in an energy recovery system 106 to convert geothermal energy captured by the CO₂ into another usable form of energy, such as electricity. However, a large proportion of the CO₂ remains in the reservoir as a sequestration fluid. In other examples, the entirety of the CO₂ that is injected into the reservoir 104 can remain sequestered in the reservoir 104 permanently or substantially permanently, e.g., with none of the sequestered CO₂ being produced back to the surface and, therefore, with no need for an energy recovery system at the surface.

In an example, the CO₂ 102 is provided by a CO₂ source 108, such as a CO₂ emitter, for example a power plant, an industrial plant, another production facility, such as a cement or concrete production facility, or an underground source. The CO₂ source 108 can be provided from an air-capture source or any other source. The CO₂ 102 can be in liquid form, gaseous form, supercritical form, or a mixture of two or more forms of CO₂. In an example, the CO₂ 102 that is to be injected into the reservoir 104 is supercritical CO₂. Supercritical CO₂ has an increased density as compared with other working fluids, including gaseous carbon dioxide, such that a greater amount can be stored in a smaller volume, thus increasing system efficiency. Additionally, supercritical CO₂ has favorable chemical properties and interaction characteristics with water, such as saline water. Supercritical CO₂ can also be used in colder conditions since it has a very low freezing point of about −55° C. (depending on the pressure). As such, a carbon dioxide-based system can be used in temperatures much lower than 0° C., such as down to −10° C. or −20° C. or −30° C. or below, down to about −55° C., including any range there between. A larger temperature differential between the heat sink (atmosphere or ambient air) and the heat source (e.g., geothermal heat 110 in the reservoir 104), also increases the overall efficiency of the system, in cases where a portion of the CO₂ is produced for geothermal energy recovery and conversion (described in more detail below).

In an example, each system 100 and 200 is located at a site (i.e., in a position) configured to provide access to a target formation that includes the reservoir 104. The reservoir 104 can include a geological formation that is sufficiently porous such that the injected CO₂ 102 can permeate through the reservoir 104 in the form of a CO₂ plume 112 (described in more detail below). Examples of geological formations that can form the reservoir 104 include, but are not limited to, sandstone and carbonates. In an example, the reservoir 104 comprises a native fluid 114, such as brine when the reservoir 104 is a saline aquifer.

In an example, the target formation may include one or both of a top layer 116 located above at least a portion of the reservoir 104, and a caprock 118 located above at least a portion of the reservoir 104 and below at least a portion of the top layer 116.

If present, the top layer 116 can include any number of layers and types of natural deposits and/or formations. For example, the top layer 116 can contain or cover one or more features such as a reservoir (e.g., the reservoir 104) or caprock (e.g., the caprock 118) having the features as described herein. The top layer 116 can include one or more layers of sediment and/or soil of varying depths, and additionally or alternatively any type of rock, including rocks or sediments in layers, rock or sediment formations, and the like, or any combinations thereof. In an example, the top layer 116 additionally or alternatively comprises a top layer or layers of sediment and/or soil of varying depths. The permeability and/or porosity of the top layer 116 may vary widely, as long as drilling can be performed to insert an injection well 120 and, optionally, a production well 122. In an example, the top layer 116 can have a wide range of depths (i.e., “thickness”) sufficient to ensure that the CO₂ 102 that is introduced into the reservoir 104 remains in the desired state, such as a supercritical state. In an example, the depth of the top layer 116 is at least 100 meters (m) or more, up to one (1) kilometer (km), further including more than one (1) km, such as up to three (3) km, four (4) km, five (5) km, or more, such as up to 10 km or over 15 km including any range between and including any combination of the values listed above, such as from about one (1) km to about five (5) km, below the Earth's surface (i.e., below or within a given topography in an area, which may or may not be exposed to the atmosphere). However, the target formation is not limited to any particular depth for the top layer 116.

If present, the caprock 118 can be a geologic feature overlying at least a portion of the reservoir 104. In an example, the caprock 118 has a very low permeability, i.e., in the nano-Darcy range (10⁻⁶ millidarcies or less). A low permeability allows the caprock 118 to essentially function as a barrier for fluid contained in the reservoir 104 below. Permeability may also be dependent, in part, on the depth (i.e., thickness) of the caprock 118, as well as the depth of the top layer 116 above. The porosity of the caprock 118 can vary widely. As is known in the art, even if a rock is highly porous, if voids within the rock are not interconnected, fluids within the closed, isolated pores cannot move. In other examples, the caprock 118 may have a permeability that does not prevent or inhibit fluid leakage from the reservoir 104, but rather containment of the fluid or fluids may be because the reservoir 104 itself comprises a rock formation that has a very low vertical permeability (i.e., the fluid cannot flow upward from the reservoir 104 except through a production well 122), while being sufficiently laterally permeable and porous so the fluid or fluids can readily flow across the reservoir 104.

The thickness of the caprock 118 can vary but is typically substantially less than the thickness of the top layer 116. In an example, the top layer 116 has a thickness on the order of 10, or 10 to 100, up to 1000 times the thickness of the caprock 118, further including any range therebetween, although the systems 100 and 200 are not limited to a caprock 118 having this thickness or even to a reservoir having a caprock at all. In an example, the thickness of the caprock 118 can vary from about one (1) cm up to about 1000 m or more, such as between about five (5) cm and 1000 m, such as between about one (1) m and about 100 m. In an example, the caprock 118 represents more than one caprock layer, such that multiple caprocks are present which partially or completely cover one another and may act jointly as a caprock 118 to prevent or reduce upward leakage of the working fluid from the reservoir 104.

In an example, the reservoir 104 comprises one or more natural underground rock reservoirs capable of containing fluids while still allowing relatively free flow of fluid within the reservoir 104 in at least one direction. The caprock 118 and the reservoir 104 can be made up of a variety of rock types, including, but not limited to: igneous rock; metamorphic rock; limestone; sedimentary rock; shale; crystalline rock; and combinations thereof. In an example, the reservoir 104 is a previously created manmade reservoir or a portion of a previously created manmade reservoir, such as, for example, shale formations remaining from shale fracturing for hydrocarbon removal. In an example, the caprock 118 and/or the reservoir 104 are capable of storing the injected CO₂ 102 on a substantially “permanent” basis, e.g., so that the reservoir 104 can be considered as a “sequestration reservoir,” as these terms are understood in the art.

As noted above, the CO₂ 102 is delivered to an injection well 120, wherein the CO₂ 102 flows in a substantially downward direction below the Earth's surface until it reaches one or more injection well openings 124, through which the CO₂ 102 is released into the reservoir 104. As described in more detail below, in an example, the injection well 120 comprises a plurality of openings 124, for example in the form of a plurality of perforations in the tubing that forms at least a portion of the injection well 120 so that the CO₂ 102 will enter the reservoir 104 over a wide area.

In an example, the CO₂ 102 permeates the reservoir 104 and forms a CO₂-based plume 112 (which may also be referred to simply as “the CO₂ plume 112” for brevity, even if the plume 112 is not entirely CO₂). In an example, the CO₂ plume 112 is exposed to the temperatures of the reservoir 104, which can be higher than the temperature of the CO₂ 102 that is fed into the injection well 120. In such a case, the CO₂ 102 absorbs heat from the reservoir 104, which can result in an upwardly migrating CO₂ plume 112 within the reservoir 104. In an example, the CO₂ plume 112 can be laterally advected due to non-zero groundwater flow velocities within the reservoir 104. In an example, lateral migration occurs additionally or alternatively due to the CO₂ plume 112 spreading, as additional CO₂ 102 exits the injection well 120 and pushes fluid through the reservoir 104.

In an example, the CO₂ 102 can interact with a native fluid 114 that is within the reservoir 104. For example, the native fluid 114 can comprise one or more hydrocarbons and the CO₂ 102 can interact with the one or more hydrocarbons. In another example, the reservoir 104 comprises an aquifer, e.g., a saline aquifer, or a saline or water-filled rock formation such that the native fluid 114 can include a brine solution. In an example, at least a portion of the native fluid 114, such as a portion of the one or more hydrocarbons or the brine, can combine with the original CO₂ 102 to form a portion of the CO₂ plume 112. In another example, the reservoir 104 contains little to no native fluid or the native fluid 114 that is present does not interact and/or does not combine with the CO₂ 102 to form part of the CO₂ plume 112.

As the CO₂ plume 112 moves through the reservoir 104, it can become heated by the geothermal heat 110 that is present in or is supplied to the reservoir 104. The geothermal heat 110 can raise the temperature of the CO₂ plume 112, raise the pressure of the CO₂ plume 112, or both, and in particular raise the temperature of the injected CO₂ 102, raise the pressure of the injected CO₂ 102, or both, within the CO₂ plume 112 compared to the temperature of the CO₂ 102 as it exits the injection well 120.

In an example, the CO₂ plume 112 can incorporate one or more components of a native fluid 114, which can be in the form of the one or more components being at least partially dissolved in the CO₂ plume 112 or included as individual bubbles or fluid pockets dispersed throughout the CO₂ plume 112.

The CO₂ plume 112, which may or may not include one or more components of the native fluid 114, can migrate, be transported, flow, and/or spread through the reservoir 104 until it encounters the caprock 118, which prevents further upward transmission of the CO₂ 102 such that the caprock 118 contains the CO₂ 102 within the reservoir 104.

As mentioned above, in an example the systems 100, 200 can be configured to recover a portion of the CO₂ 102 that had been injected into the reservoir 104. In such an example, the system 100, 200 can include one or more production wells 122 through each of which a portion of the CO₂ plume 112 can be returned to the surface as part of a production fluid 126. In such an example, the CO₂ plume 112 migrates, permeates, spreads, or is otherwise transported through the reservoir 104 towards the production well or wells 122, where the production fluid 126 portion of the CO₂ plume 112 enters a production well opening 128 and flows into the production well 122. In an example, the production well 122 comprises a plurality of openings 128, for example in the form of a plurality of perforations in the production well 122.

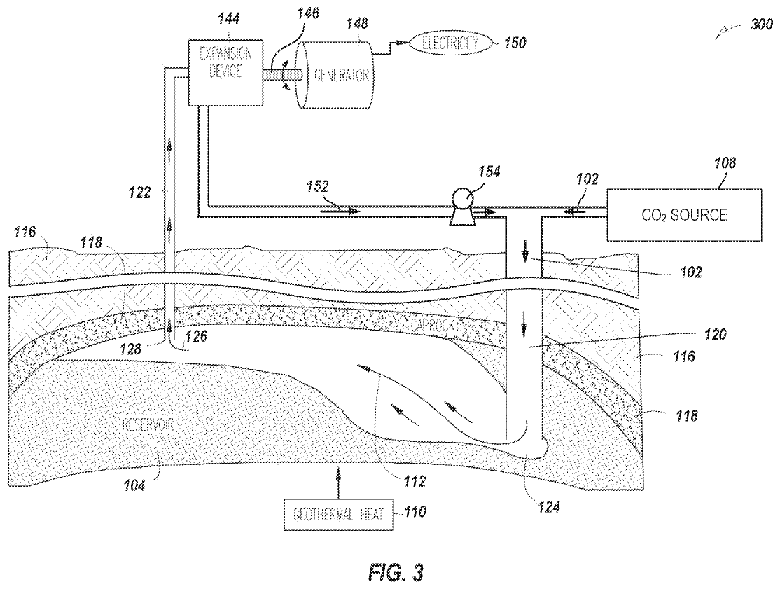

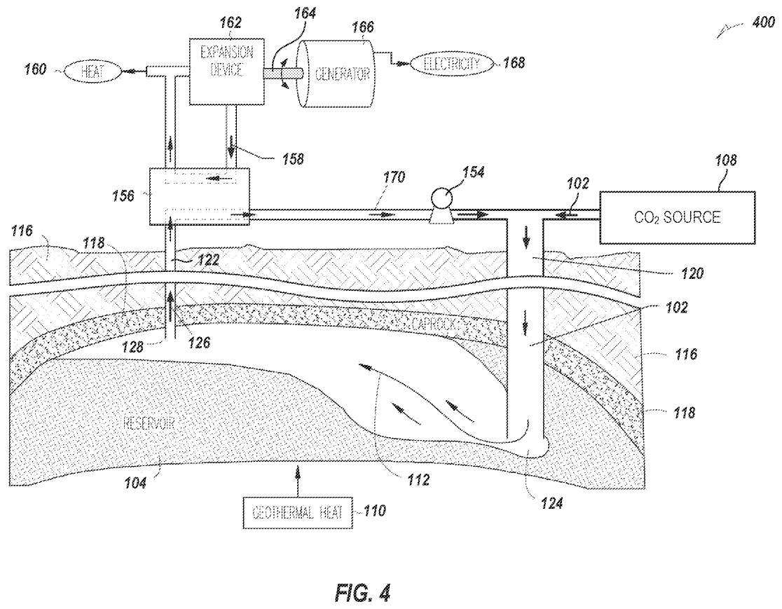

When the CO₂ plume 112 reaches the one or more production well openings 128, the production fluid 126 can be transported via a pressure differential and/or buoyantly move in a generally upwardly direction towards the Earth's surface through the production well 122. At the surface, the production fluid 126 can be fed into an energy recovery system 106 that can convert energy in the production fluid 126 to another form of energy, such as electricity, heat, or a combination thereof. The energy recovery system 106 can include any apparatus or system configured to recover energy from a portion or all of the production fluid 126, including, but not limited to, any or all of the components described below for an electricity-generating system or heat-energy recovery system described below with respect to FIGS. 3 and 4.

The generic systems 100 and 200 of FIGS. 1 and 2 can also include a separation system 130 for separating one or more components from the production fluid 126. In particular, the separation system 130 may be included if there is a native fluid 114, and one or more components of the native fluid 114, such as a brine or one or more hydrocarbons, are included in the production fluid 126.

The separation system 130 can include any separation operation that is known in the art for separating components from the production fluid 126. For example, the separation system 130 can include one or more operation units for separating CO₂, from hydrocarbons, from other native fluids such as water or brine, or from injected fluids such as a working fluid that comprises a substantial amount of water. The separation system 130 can also include one or more separation operation units for separating hydrocarbons from other native fluids such as water or brine. Examples of separation operation units that can be used for the separation of CO₂, hydrocarbons, or other native fluids, include, but are not limited to: distillation units, such as one or more distillation columns; absorption units, such as one or more absorption columns; chromatography units; density separation units, such as centrifuges, cyclone separators, decanters and the like; crystallization or recrystallization units; electrophoresis units; evaporation or drying units; extraction units, such as leaching, liquid-liquid extraction, or solid-phase extraction; stripping units; and the like.

In an example, shown in FIGS. 1 and 2, the separation system 130 is configured to separate the production fluid 126 into a CO₂-based stream 132, a hydrocarbon stream 134, and a brine stream 136 (which can include other injected fluids such as a water-containing working fluid). Each stream 132, 134, 136 can be further treated or processed after separation. For example, the CO₂-based stream 132 can be fed back into the reservoir 104, such as by feeding the CO₂-based stream 132 into a compressor and/or a cooling unit 138 for reinjection back into the injection well 120, as shown in FIGS. 1 and 2. The hydrocarbon stream 134 can be delivered to a refining system to further refine the one or more hydrocarbons into various petroleum products. The brine solution stream 136 can be sold as a product, further treated, delivered back into the reservoir 104, released at the land surface or injected into other subsurface formations, or can be disposed of otherwise.

The separation system 130 can be configured to be operated before, i.e., upstream of, the energy recovery system 106, or the separation system 130 can be operated after, i.e., downstream of, the energy recovery system 106. FIG. 1 shows an example system 100 with the separation system 130 being positioned downstream of the energy recovery system 106 so that energy, for example in the form of heat or electricity, can be recovered from the production fluid 126 before separating the production fluid 126 into separate components. In such a system, the energy recovery system 106 can be configured to recover heat from the production fluid 126 in its entirety. After energy is recovered from the production fluid 126, the fluid can exit the energy recovery system 106 as one or more fluids 140 that are in a cooled, and possibly expanded (e.g., lower pressure), state. The cooled fluid 140 can be fed into the separation system 130 to be separated into the various separated streams 132, 134, 136.

In the example system 200 of FIG. 2, the separation system 130 is positioned upstream of the energy recovery system 106 so that the CO₂-based stream 132, the hydrocarbon stream 134, and the brine stream 136 can be separated before energy is recovered from each stream in the energy recovery system 106. In such a configuration, the energy recovery system 106 can include a separate dedicated energy recovery device or devices for each stream 132, 134, 136, such as a first energy recovery device or devices 142A configured to recover energy from the CO₂-based stream 142, a second energy recovery device or devices 142B configured to recover energy from the hydrocarbon stream 134, and a third energy recovery device or devices 142C configured to recover energy from the brine solution stream 136.

Alternatively, the production fluid 126 can include a large percentage of one component, such as up to about 99 wt. % CO₂, so that dedicated energy recovery device or devices for each of the remaining components (that make up part of the remaining 1 wt. %) may not be practical. In such a situation, the separation system 130 can be configured to separate out only the component with the large mass percentage, such as the CO₂, and leave the other components in a combined stream. Also, the energy recovery system 106 can include only a first energy recovery device or devices configured to recover energy from the large-percentage component, and a second energy recovery device or devices for the other components. If the mass percentage of the other components is small enough, it may even be desirable to only recover energy from the large-percentage component, and to forgo energy recovery from the other components.

In the examples shown in FIGS. 1 and 2, each set of the one or more dedicated energy recovery devices can be used to recover energy from the CO₂-based stream 132, the hydrocarbon stream 134, and the brine solution stream 136. Because each stream 132, 134, 136 can have its own dedicated energy recovery device or devices 142A, 142B, 142C, each dedicated energy recovery device or devices 142A, 142B, 142C can be configured for the specific stream 132, 134, 136.

In the energy recovery system 100 in which the fluid separation system 130 is downstream of (e.g., after) the energy recovery system 106, heat or pressure energy are not lost in the fluid separation system 130 prior to energy recovery in the energy recovery system 106. Thus, it can be possible for more energy in the production fluid 126 to be converted into electricity, heat, or a combination of electricity and heat for direct use. However, in the system 100, the production fluid 126 can be less likely to be suitable for use directly in an expansion device. Rather, the production fluid 126 may be required to be sent through a heat exchanger, providing thermal energy to a secondary working fluid that in turn is sent through an expansion device in what is generally referred to as a “binary system.” Examples of binary systems include, but are not limited to, Organic Rankine Cycle (ORC) and Kalina systems. The use of a heat exchanger and a binary system can decrease overall efficiency in conversion of energy from the production fluid 126 to electricity or heat, or both, for direct use.

In contrast, in the system 200 in which the separation system 130 is upstream of (e.g., before) the energy recovery system 106, each fluid stream 132, 134, 136 can be sent through a corresponding energy recovery apparatus 142A, 142B, 142C specifically designed for the composition of each component of the separated production fluid 126, such as the first energy recovery device or devices 142A for the CO₂-based stream 132, the second energy recovery device or devices 142B for the hydrocarbon stream 134, and the third energy recovery device or devices 142C for the brine or water stream 136. Thus, the energy recovery efficiency for each fluid stream 132, 134, 136 can be optimized, which may be limited in the case of separation downstream of (e.g., after) energy recovery (as described above with respect to FIG. 1). In an example, the energy recovery device or devices 142B, 142C for cases where the hydrocarbon stream 134 that is liquid or primarily liquid and the brine or water stream 136 can be an Organic Rankine Cycle or other binary system, potentially with different secondary working fluids. However, for the CO₂-based stream 108 and cases where the hydrocarbon stream 1134 is gaseous or primarily gaseous, the energy recovery apparatus 142A, 142B can be a direct turbine because the lower density of these gaseous or supercritical fluids can provide much more energy in the form of electricity than higher density fluids in liquid phase when decreasing between the same pressure levels. Passing a low-density fluid through a direct turbine followed by a cooling apparatus generally can produce more electricity than extracting thermal energy to operate an Organic Rankine Cycle or other binary system, and then decreasing the pressure through a valve or turbine, when operating between the same inlet and exit conditions.

FIGS. 3 and 4 show other example systems 300 and 400, respectively, for recovering geothermal heat captured by the production fluid 126 and using it to generate electricity, heat, or a combination thereof. The front ends of both the system 300 of FIG. 3 and the system 400 of FIG. 4 can be similar to the systems 100, e.g., with CO₂ 102 supplied by a CO₂ source 108 to one or more injection wells 120 to deliver the CO₂ 102 to the reservoir 104 and one or more production wells 122 that produce a portion of the resulting CO₂ plume 112 as at least part of a production fluid 126 for energy recovery.

In the system 300 shown in FIG. 3, the production fluid 126 is fed into an expansion device 144 after being produced from the production well 122. The flow of the production fluid 126 through the expansion device 144 produces shaft power 146 which can be used by a generator 148 to produce electricity 150. The expansion device 144 can comprise any suitable type of expansion device 144 known in the art, including any type of turbine, although the systems described herein are not limited to a turbine. In an example, the expansion device 144 can include, but is not limited to: a piston-cylinder device; or a scroll, screw, or rotary compressor designed to run in reverse as engines.

The production fluid 126 exits the expansion device 144 as a warm CO₂-based stream 152. In an example, the warm CO₂-based stream 152 is primarily supercritical CO₂ having a temperature of at least about 30° C. (at least about 90° F.) and/or no more than about 100° C. (no more than about 215° F.), such as from about 35° C. (about 100° F.) to about 95° C. (about 200° F.), for example from about 50° C. (about 120° F.) to about 80° C. (about 175° F.), and a pressure of at least about 7.5 MPa (at least about 1100 psia) and/or no more than about 17.2 MPa (no more than about 2500 psia), such as from about 8.3 MPa (about 1200 psia) to about 16.5 MPa (2400 psia), for example from about 8.3 MPa (1200 psia) to about 15.9 MPA (2300 psia), or from about 9 MPa (1300 psia) to about 15.2 MPa (about 2200 psia). The CO₂-based stream 152 can be injected directly into the injection well 120 to provide a portion of the CO₂ 102 that is injected into the reservoir 104. In an example, the CO₂-based stream 152 can be fed through an optional pump 154 before being fed into the injection well 120, e.g., as part of the CO₂ 102 that is being injected into the reservoir 104.

In an example, a portion of the shaft power 146 produced by the one or more expansion devices 144 can be used to drive one or more components of the system 100 instead of or in addition to producing electricity (not shown). For example, a portion of the shaft power 146 can be used to drive the compressor or pump 154 to re-pressurize the CO₂-based stream 152 in order to inject it back into the reservoir 104 via the one or more injection wells 120.

In another example system 400, shown in FIG. 4, the heated production fluid 126 passes through a heat exchanger 156 where it warms a secondary working fluid 158 also cycling through the heat exchanger 156. Heat 160 can be released from at least a portion of the heated secondary working fluid 158 and can be used in any direct use application and/or as a ground-source heat pump, using components well known in the art. In an example, at least a portion of the heated secondary working fluid 158 can be fed into an expansion device 162, which can be similar or identical to the expansion device 144 described above, except that the expansion device 144 in FIG. 3 is a direct expansion device while the expansion device 162 is part of a binary power cycle. Like the expansion device 144, the expansion device 162 produces shaft power 164 that can be used to drive a generator 166 to produce electricity 168. The production fluid 126 exits the heat exchanger 156 as a cooled CO₂-based stream 170, which can be a condensed liquid in some examples. The cooled CO₂-based stream 170 can be passed through an optional pump or compressor 154, which can be similar or identical to the compressor or pump 154 described above with respect to the system 300. The cooled CO₂-based stream 170 can then be injected into the injection well 120 as a portion of the CO₂ 102.

### Brine Withdrawal to Enhance Sequestration Fluid Injectivity

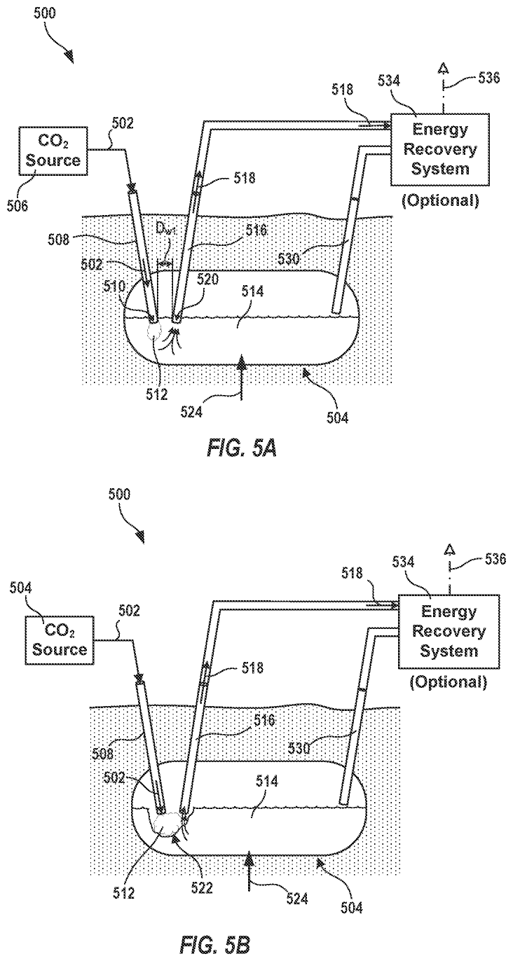

Turning to FIGS. 5A-5D, an example system 500 is shown for improving or enhancing injectivity of a sequestration fluid 502, such as CO₂ 502, into a reservoir 504, for example from a CO₂ source 506 such as a CO₂ emitter. In an example, the reservoir 504 comprises a deep saline aquifer that is particularly suitable for CO₂ sequestration. For example, saline aquifer reservoirs are often relatively thick and often have large areal extents, which can combine to provide relatively large pore volumes, which can potentially accommodate many years of high CO₂ production rates from one or more CO₂ emitters. As will be appreciated by those having skill in the art, high flow rates of CO₂ will need to be injected into an aquifer 504 through one or more injection wells 508 in order to accommodate high rates of CO₂ production by the one or more CO₂ emitters. As will also be appreciated by those of skill in the art, injection of high flow rates of CO₂ into the aquifer 504 requires displacing a native fluid 514 such as brine from the pore volume in order to make room for the CO₂ being sequestered. However, the relatively high viscosity of the brine compared to that of CO₂ and the relative permeability of the geological formation to the flow of brine and CO₂ tends to cause elevated pressure in the aquifer's rock formation near the point(s) of injection of the CO₂, e.g., at the one or more injection well reservoir openings 510, for example as a CO₂ plume 512 is being formed. In addition, because CO₂ has a substantially lower viscosity than the brine, the bottom hole pressure of the injection well 508 can rise very quickly by as much as 300 psi (about 2.07 megapascals) or more near the wellbore. This can cause potentially damaging backpressure on the injection system and can cause local fracturing of the aquifer rock near the wellbore and induced seismic events within the aquifer 504. It is preferred that fracturing and induced seismic events be avoided because it can adversely affect the ability of the aquifer reservoir 504 to contain the CO₂. Therefore, during an initial startup stage (e.g., during the first few years of CO₂ injection), the injection rate for each injection well may need to be limited in order to avoid fracturing. The limited available injection rate for each injection well 508 can mean that more injection wells are needed in order to accommodate desired injection rate of the CO₂, e.g., so that the injection rate matches the emission rate produced by the CO₂ source 506. This, in turn, will increase the overall capital and operating costs for the system for the additional injection wells 508, even though the additional injection wells 508 may only be needed for the first few years of injection.

The example system 500 of FIGS. 5A-5D provides a solution to this problem via managed withdrawal of brine 514 proximate to the injection well or wells 508 in order to manage the injection well bottom hole pressure, which can minimize the number of injection wells that are needed to correspond to a specified injection rate (e.g., based on the CO₂ production rate from the one or more CO₂ emitters that make up the CO₂ source 506. In an example, the system 500 is configured to inject a sequestration fluid 502, for example CO₂ 502, into an underground brine aquifer 504 (also referred to as the underground reservoir 504 or simply as the reservoir 504). The CO₂ 502 can be provided from a CO₂ source 506, such as one or more CO₂ emitters. The CO₂ source 506 can also include a compressor or pump (not shown in FIGS. 5A-5D), similar to the compressor 138 in FIGS. 1 and 2 or the pump 154 shown in FIGS. 3 and 4. The CO₂ 502 is injected via one or more injection wells 508 where the CO₂ 502 exits the injection well 508 via an injection well reservoir opening 510. As described above, in an example, the injection well opening 510 can comprise a plurality of openings, such as a plurality of perforations in the casing of the injection well 508 so that the CO₂ 502 will be injected into the reservoir 504 over a relatively wide area.

As the CO₂ 502 exits the one or more injection well openings 510 it forms a CO₂ plume 512. As the CO₂ plume 512 expands, it displaces brine 514 that is present within the reservoir 504. As noted above, because the brine 514 has a higher viscosity than the CO₂ 502, the bottom hole pressure at or near the injection well opening 510 can rise quickly leading to backpressure on the injection system and can lead to local fracturing of the rock formation portion of the aquifer 504 at or proximate to the injection well opening 510. In order to alleviate this pressure, the system 500 can includes one or more withdrawal wells 516 corresponding to each of the one or more injection wells 508. Each of the one or more withdrawal wells 516 are configured to withdraw a portion 518 of the native brine 514 from the aquifer 504 during the initial formation of the CO₂ plume 512, as shown in FIG. 5A.

In an example, each withdrawal well or wells 516 are positioned so that they are proximate to one or more corresponding injection wells 508, e.g., such that a withdrawal well opening 520 is located within a specified well distance D_{w1} from the one or more injection well openings 510 of a corresponding injection well 508. In an example, the specified distance between the withdrawal well opening or openings 520 and the injection well opening or openings 510 is from about 30 meters (about 100 feet) to about 3000 meters (about 10,000 feet). The actual specified well distance D_{w1} that is chosen can depend on several factors including, but not limited to, the injection rate of the CO₂ 502 through the injection well 508, the rate of withdrawal of the brine portion 518 through the withdrawal well 516, the density of the CO₂ plume 512 within the aquifer 504, the density of the brine 514 within the aquifer 504, the viscosity of the CO₂ in the CO₂ plume 512, the viscosity of the brine 514, the permeability of the rock formation of the aquifer 504 to the CO₂ of the CO₂ plume 512, the permeability of the rock formation of the aquifer 504 to the brine 514, the pressure of the brine 514 at or proximate to the one or more withdrawal well openings 520, and the composition of the brine 514. In an example of a series of withdrawal wells 516, 526, it may be desirable for at least one of the withdrawal wells to be at least about 300 meters (about 1000 feet) from the forecasted edge of the CO₂ plume 512. Therefore, if the edge of the CO₂ plume 512 gets within 300 meters (withing about 1000 feet) of the last withdrawal well that has been drilled, it may be preferred to drill an additional withdrawal well that is further from the forecasted edge of the CO₂ plume to maintain the at least 300 meter (at least 1000 feet) spacing.

As the brine portion 518 is withdrawn through the one or more withdrawal wells 516, it creates pore volume space for the CO₂ plume 512, shown schematically in FIG. 5B as the vacated pore space 522. The vacated pore space 522 makes room for the expanding CO₂ plume 512 around the outlet opening or openings 510 and alleviates pressure within the aquifer 504 as the CO₂ 502 continues to be injected. The withdrawal of the brine portion 518 and the resulting vacated pore space 522 provides for a reduced likelihood that the pressure of the CO₂ plume 512 will rise beyond the fracturing pressure of the rock formation that makes up the aquifer 504 and/or that the CO₂ in the CO₂ plume 512 will create unwanted backpressure in the injection system that feeds the CO₂ 502 to the one or more injection wells 508.

Once the CO₂ plume 512 permeates far enough to reach the withdrawal well 516, the withdrawal of the withdrawn brine portion 518 through the withdrawal well can be ceased, as shown in FIG. 5C. In an example, the withdrawal well 516 can simply be shut off at this point while the CO₂ plume 512 continues to permeate through the aquifer 504. In another example, which is not shown in FIG. 5C, the withdrawal well 516 can be used as an initial production well for a portion of the CO₂ from the CO₂ plume 512 or for the production of a native fluid such as methane or hydrocarbon that may be present in the aquifer 504. Whether or not it will be desirable to produce a portion of the CO₂ plume 512 through the one or more withdrawal wells 516 will depend on the rate of geothermal heat 524 flowing into the aquifer 504 that is capable of being passed to the CO₂ plume 512. In other words, the choice to produce a portion of the CO₂ plume through the one or more withdrawal wells 516 can depend on whether it is expected that the geothermal heat 524 can sufficiently heat the CO₂ plume 512 in the time it takes the CO₂ plume 512 to reach the one or more withdrawal wells 516 to make production of a portion of the CO₂ plume at the one or more withdrawal wells 516 economically viable, e.g., for the purpose of electricity generation. In some examples, the CO₂ plume 512 may not be sufficiently heated by the time it reaches the withdrawal well 516 so that the temperature of the CO₂ in the CO₂ plume 512 is not sufficiently high for economical geothermal energy recovery.

If the pressure of the CO₂ plume 512 is still a problem, e.g., if the CO₂ plume 512 still takes up a small enough space in the aquifer that the incremental injection of the CO₂ 504 at the current injection rate can still lead to fracturing of the aquifer 504 or unwanted backpressure by the time the CO₂ plume 512 reaches the one or more withdrawal wells 516, than the system 500 can include one or more additional withdrawal wells such as the second withdrawal well 526 shown in FIG. 5C. As can be seen, the second withdrawal well 526 is located a second specified well distance D_{w2} away from the injection well 508, wherein the second specified well distance D_{w2} is larger than the first specified well distance D_{w1} between the first withdrawal well 516 and the injection well 508. Similar to the one or more first withdrawal wells 516, the one or more second withdrawal wells 526 can withdraw a portion 528 of the brine 514 from the aquifer 504, which can provide even more pore space for the CO₂ plume 512, e.g., beyond the vacated pore space 522 produced by brine withdrawal into the first withdrawal well 516. In an example, the first and second withdrawal wells 516, 526 can be operated at the same time, e.g., from the initial time of injection of the CO₂ 502 through the injection well 508. In another example, the first and second withdrawal wells 516, 526 can be operated sequentially, e.g., with the first withdrawal well 516 being operated during initial formation of the CO₂ plume 512 and the second withdrawal well 526 being operated after the CO₂ plume 512 reaches the first withdrawal well 516.

Additional withdrawal wells can be positioned at other points within the aquifer 504 other than what is shown for the first and second withdrawal wells 516, 526, such as on lateral sides of the injection well 508, closer to the injection well 508 than the first withdrawal well 516, between the location of the first and second withdrawal wells 516, 526, or farther away from the injection well than the second withdrawal well 526.

In an example, the aquifer 504 can be configured not only as a sequestration reservoir 504, but also as a geothermal energy recovery reservoir 504. In such an example, the system 500 can include one or more production wells 530 that are capable of producing one or more working fluids to the surface. As shown in FIG. 5C, at some point in time, the CO₂ plume 512 can become sufficiently large that it displaces the brine 514 so that a portion of the brine 514 encounters the production well 530 so that a portion 532 of the brine 514 can be produced to the surface. The brine portion 532, which can carry heat energy provided by the geothermal heat flow 524, can then be passed through an optional heat recovery system 534 where the captured geothermal heat carried by the brine portion 532 can be converted to another form of energy, such as direct use heat or electricity 536.

The CO₂ plume 512 can permeate and expand across the aquifer 504. As the CO₂ plume 512 permeates across the aquifer 504, a portion of the geothermal heat flow 524 can be absorbed by the CO₂ plume 512, which can raise the temperature of the CO₂ in the CO₂ plume 512, raise the pressure of the CO₂ in the CO₂ plume 512, or both. Eventually, as shown in FIG. 5D, the CO₂ plume 512 can expand or otherwise permeate far enough through the aquifer 504 that it encounters one or more production wells 530 such that a production fluid 538 that includes at least a portion of the CO₂ from the CO₂ plume 512 can enter the production well 530 and be produced to the energy recovery system 534. In an example, the production fluid 538 comprises from about 0.01 wt. % to about 99 wt. % CO₂ produced from the CO₂ plume, with the remainder being one or more native fluids from the aquifer 504, such as a portion of the brine 514 from the aquifer 504. The production fluid 538 can be fed into the energy recovery system 534 to convert at least a portion of the absorbed heat energy in the production fluid 538 to one or more other types of usable energy, such as electricity 536.

In an example, one or more of the withdrawn brine portions 518, 528, 532 can also be fed into the energy recovery system 534 to convert geothermal heat 524 that had been absorbed by the brine portions 518, 528, 532 to another usable form of energy, such as direct use heat or electricity.

Examples of further aspects that can be included in the energy recovery system 534 are described in U.S. Pat. No. 8,316,955, entitled “CARBON DIOXIDE-BASED GEOTHERMAL ENERGY GENERATION SYSTEMS AND METHODS RELATED THERETO;” U.S. Pat. No. 8,991,510, entitled “CARBON DIOXIDE-BASED GEOTHERMAL ENERGY GENERATION SYSTEMS AND METHODS RELATED THERETO;” U.S. Pat. No. 9,869,167, entitled “CARBON DIOXIDE-BASED GEOTHERMAL ENERGY GENERATION SYSTEMS AND METHODS RELATED THERETO;” U.S. Provisional Patent Application Ser. No. 62/706,518 to Phil Pogge, et al., filed on Aug. 21, 2020 with Attorney Docket No. 3762.002PRV, entitled “POWER GENERATION FROM SUPERCRITICAL CARBON DIOXIDE,” and U.S. Provisional Patent Application Ser. No. 63/190,620 to Larry G. Chorn et al., filed on May 19, 2021 with Attorney Docket No. 3762.003PRV, entitled “SYSTEM AND METHOD FOR GEOTHERMAL ENERGY GENERATION WITH TWO-PHASE WORKING FLUID,” the disclosures of which are incorporated herein by reference in their entireties.

A computer simulator was run to model the behavior of the injected CO₂ 502 in the aquifer 504. The simulator was tuned with a characterization of the aquifer, e.g., including a characterization of the volumetric distribution of rock properties (e.g., porosity, permeability to the CO₂ 502 and the brine 514, irreducible brine saturation levels, layer thickness, and area extent). The injection well 508 was located within the aquifer volume and its operating conditions were fixed (e.g., the injection rate of the CO₂, the bottom hole pressure limit, CO₂ viscosity and density at the temperature and pressure in the aquifer). The withdrawal well 516 was located the specified well distance D_{w1} away from the injection well 508 for managed brine withdrawal. The bottom hole pressure of the withdrawal well 516 was selected based on the production rate of the brine portion 518 through the withdrawal well 516.

The reservoir simulator was run multiple times with different bottom hole pressures for the one or more withdrawal wells 516 to optimize the withdrawal rate to match or substantially match the CO₂ injection rate. The specified well distance D_{w1} can also be optimized by repeated simulator runs.

### Deviated or Highly Deviated Wells For Enhanced Pressure Management

In the example systems 100, 200, 300, 400, and 500 shown in FIGS. 1-4 and 5A-5D each of the wells (e.g., the injection wells 120, 508, the production wells 122, 530, and the brine withdrawal wells 516, 526) are depicted as being vertically or substantially vertically oriented. However, in an example, one or more of the wells are so-called deviated wells. As used herein, the term “deviated well” refers to a well comprising an elongated portion of the tube or pipe of the well that is within the reservoir (e.g., within a saline aquifer) that extends in a direction that deviates from vertical by from about 10° to about 90° (wherein deviating 90° from vertical results in a portion of the well being horizontal or substantially horizontal), e.g., from about 30° to about 90° from vertical, such as from about 45° to about 90° from vertical, for example from about 60° to about 90° from vertical, such as from about 65° to about 90° from vertical, for example from about 70° to about 90° from vertical, such as from about 75° to about 90° from vertical, for example from about 80° to about 90° from vertical, such as from about 85° to about 90° from vertical. As used herein, the term “vertical,” when referring to an elongated portion of a well that is within the reservoir, is a direction that is normal or substantially normal to the general plane of the Earth's surface. As used herein, the term “horizontal,” when referring to an elongated portion of a well that is within the reservoir, is a direction that is parallel or substantially parallel to the general plane of the Earth's surface.

As described above, the relatively high viscosity of brine compared to that of CO₂ and the relative permeability of the geological formation to the flow of brine and CO₂ tends to cause elevated pressure in the aquifer's rock formation near the point(s) of CO₂ injection. This can result in backpressure on the injection system and can cause local fracturing of the aquifer rock near the wellbore and induced seismic events within the aquifer. In other words, the injection rate of the CO₂ can be constrained by limits on the pressure of the CO₂ at the perforations or other injection well openings. Constraining the bottom hole pressure below the aquifer's fracture pressure reduces the injectivity rate of CO₂ into the aquifer for conventional vertical injection wells, which forces the operator to drill additional injection wells in order to safely inject CO₂ without fracturing and induced seismic activity.

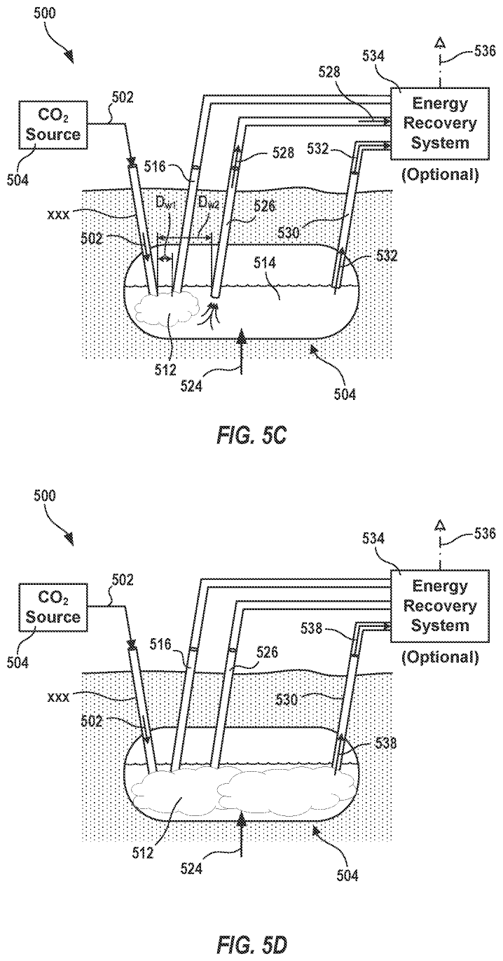

FIG. 6 shows a schematic diagram of a non-limiting example of a deviated or highly deviated injection well 600 that is horizontal or substantially horizontal (referred to hereinafter as “the horizontal injection well 600” or simply “the injection well 600” for brevity). However, those having skill in the art will appreciate that when the term “horizontal” is used with respect to the injection well 600, the well need not include a portion that is fully horizontal, but rather can be at another deviated or highly deviated angle relative to the vertical direction.

The horizontal injection well 600 is configured for injecting CO₂ 602, e.g., supercritical CO₂, into a brine aquifer 604. The diagram of FIG. 6 shows a boundary or edge 606 between the aquifer 604 and another rock formation 608 that is adjacent to the aquifer 604 and through which a vertical or substantially vertical portion 610 (also referred to simply as “the vertical portion 610” for brevity) of the injection well 600 vertically or substantially vertically passes from the surface down to a depth of a selected portion of the aquifer 604. Then, at a well heel 612, the tubing of the horizontal injection well 600 is bent so that an extended portion 614 runs in a direction that is deviated or highly deviated from the vertical direction. As depicted in FIG. 6, the deviated or highly deviated portion 614 extends in a horizontal or substantially horizontal direction and will therefore also be referred to as “the horizontal portion 614,” for brevity.

The horizontal portion 614 of the injection well 600 extends from the heel 612 into the aquifer 604 for a deviated injection well distance D_{IW} until the horizontal portion 614 reaches a well toe 616. In an example, the deviated injection well distance D_{IW} that the injection well 600 extends into the aquifer 604, e.g., from the aquifer boundary 606 to the toe 616, is from about 300 meters (“m”) (about 1000 feet (“ft”)) to about 3200 m (about 10,500 ft), such as from about 500 m (about 1600 ft) to about 1600 m (about 5300 ft).

The injection well 600 can have one or more injection well openings through which the CO₂ 602 can exit the injection well and enter the aquifer. In an example, the one or more injection well openings can comprise a plurality of perforations 618 in the tubing that forms the horizontal portion 614 of the injection well 600. The perforations 618 are configured such that as the CO₂ 602 flows through the tubing of the horizontal portion 614, the CO₂ 602 can escape through the perforations 618 and be injected into the aquifer 604 at several locations, as shown in the example of FIG. 6. In an example, the perforations 618 are spaced evenly or substantially evenly along the surface of the horizontal portion 614.

The inventors have found that an unfractured and stimulated long deviated or highly deviated injection well for CO₂ injection can inject substantially more than an equivalent vertical well at the same CO₂ injection pressure. For example, a deviated or highly deviated injection well having a length of 2000 feet (ft) (about 600 meter (m)) has an injection capacity that is four (4) times larger than an equivalent vertical well for the same depth and the same injection pressure, while a one (1) mile long (5280 ft, or about 1600 m) deviated or highly deviated well can result in an injection capacity that is 10.56 times larger (or 5280/2000×4) than an equivalent vertical well.

This increased injection capacity provides for considerable economic benefit and improved performance. For example, the formation of a single deviated or highly deviated well with an injection capacity of 1,000,000 tons per year (ton/yr) of CO₂ with a deviated length of 2,000 ft (about 600 m) into an aquifer with a depth of 7,000 ft (about 2,130 m) is estimated to cost about $7,500,000 to drill and complete. A comparable vertical well, e.g., with the same injection pressure, has a capacity that is one-fourth that of the single deviated or highly deviated well, i.e., with each well having an injection capacity of about 250,000 ton/yr, and is estimated to cost about $5,000,000 to drill and complete per vertical well into the same 7,000 ft deep aquifer. In order for vertical wells to achieve the same 1,000,0000 ton/yr injection capacity as the single deviated or highly deviated injection well would require four (4) vertical injection wells for a total estimated cost of 4×$5,000,000 or about $20,000,000 compared to the $7,500,000 for the single deviated or highly deviated well. In other words, just for the wells themselves, there is a savings of about $12.5 million in capital costs ($7.5 million versus $20 million), or about a 62.5% savings.

The economic benefit is even more pronounced for an even longer deviated or highly deviated injection well. For example, a comparable deviated or highly deviated well having a deviated length of one (1) mile (5280 ft, about 1600 m) has an injection capacity of about 2,640,000 ton/yr (or 5280/2000 times the capacity of the 2000-foot long version of the same deviated or highly deviated well), and is estimated to cost about $8,000,000 to drill and complete. The 2,640,000 ton/yr injection capacity of the single, mile-long deviated or highly deviated injection is equal to 10.56 times the 250,000 ton/yr capacity of a single vertical well. Therefore, it would require 11 total vertical wells to achieve the same capacity as the single mile-long deviated or highly deviated injection well, which has a total estimated cost of 11×$5,000,000 or about $55,000,000 compared to the $8,000,000 for the single, mile-long deviated or highly deviated injection well. In other words, just for the wells, there is a savings of about $47 million ($8 million versus $55 million), or about 85.5% savings.

This cost savings does not even take into consideration that the single deviated or highly deviated well is a simpler system with fewer components to build, maintain, or operate, which may further increase the cost savings compared to multiple vertical injection wells. The use of deviated or highly deviated wells rather than vertical wells may also make it possible to inject the CO₂ into a wider range of reservoir types. For example, deviated or highly deviated injection wells may be able to economically inject CO₂ into a reservoir rock matrix that has a relatively low permeability because of the larger contact area between the deviated or highly deviated injection well compared to an equivalent vertical well.

Similar deviated or highly deviated wells can be used for the injection of other fluids besides CO₂. For example, deviated or highly deviated injection wells can be used for the injection of brine into a reservoir. For example, as described above, if a portion of the native brine is withdrawn to improve injectivity of a sequestration fluid, such as CO₂, then the withdrawn brine can be reinjected into the reservoir or can be injected into a different underground reservoir via one or more deviated or highly deviated injection wells rather than a plurality of comparable vertical injection wells.

As described above, withdrawing brine from a saline aquifer can improve injectivity of CO₂, which can allow for fewer injection wells and for reduced risk of fracturing the formation or creating unwanted induced seismic events, which can lead to the loss of control of the plume in the aquifer. However, simulations of brine withdrawal indicate the need for large brine withdrawal rates in order to maintain desired CO₂ injection rates and to avoid over-pressurizing the aquifer—e.g., on the order of 1,000 barrels of brine per day from at least 10 separate withdrawal wells in order to inject 1 million ton/yr of CO₂.

The simulations also show that if vertical withdrawal wells are used, the rate of brine production in each well will require a drawdown pressure from the rock matrix into the wellbore of about 100 psia (about 0.69 MPa), which doesn't account for pressure losses across the opening or openings into the withdrawal well or across the production tubing. The inventor estimates that this could aggregate pressure losses between the formation and the tubing to as much as 150 psi (about 1.03 MPa) or more, depending on the number of openings in the vertical wellbore. Such a high drawdown pressure differential can create the potential for breakdown of the rock matrix during withdrawal of brine from the aquifer, which can result in sand production into the wellbore and potentially into the surface facilities (e.g., an energy recovery system). Sand production can lead to equipment fouling, reduced flow rate through the wellbore, and potential scouring of the wellbore and wellhead, which can cause perforations therein.

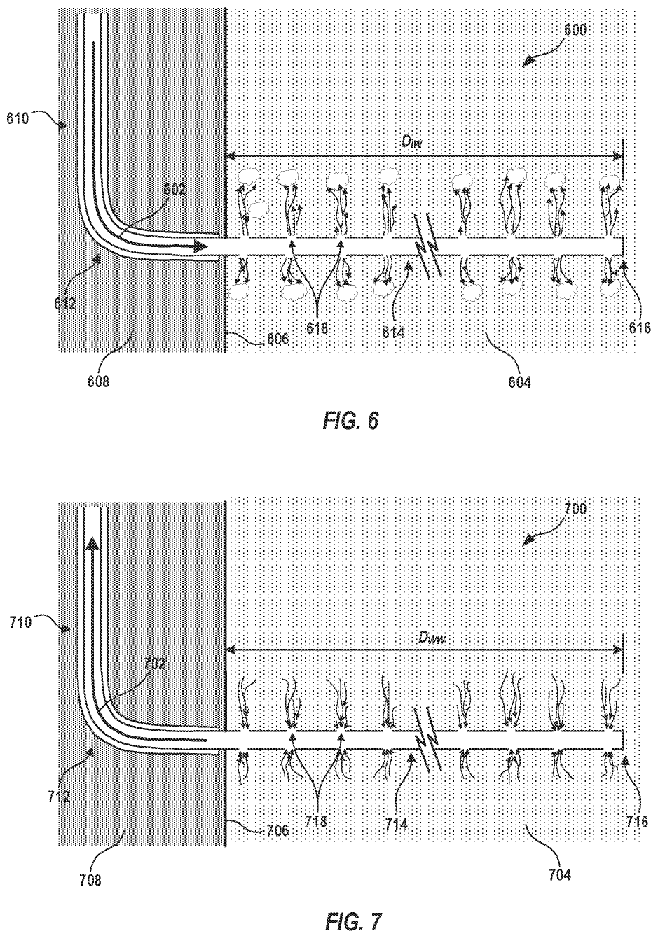

In order to avoid these problems, the present disclosure includes using one or more deviated or highly deviated wells to withdraw brine from an aquifer rather than a larger number of vertical wells. FIG. 7 shows a schematic diagram of a non-limiting example of a deviated or highly deviated brine withdrawal well 700 that is depicted with a section that is horizontal or substantially horizontal (referred to hereinafter as “the horizontal withdrawal well 700” or simply “the withdrawal well 600” for brevity). However, those having skill in the art will appreciate that when the term “horizontal” is used with respect to the withdrawal well 700, the well need not include a portion that is fully horizontal, but rather can be at another deviated or highly deviated angle relative to the vertical direction.

The horizontal withdrawal well 700 is configured for withdrawing a native fluid 702, such as brine 702, from a brine aquifer 704. FIG. 7 depicts a boundary or edge 706 between the aquifer 704 and another rock formation 708 that is adjacent to the aquifer 704 and through which a vertical or substantially vertical portion 710 (also referred to simply as “the vertical portion 710” for brevity) of the withdrawal well 700 vertically or substantially vertically passes from the surface down to a depth of a selected portion of the aquifer 704.

At a well heel 712, the tubing of the horizontal withdrawal well 700 is bent so that a deviated or highly deviated portion 714 extends in a direction that is deviated from vertical. As depicted in FIG. 7, the deviated or highly deviated portion 714 is depicted as extending in a horizontal or substantially horizontal direction and will, therefore, also be referred to as “the horizontal portion 714.” The horizontal portion 714 of the horizontal withdrawal well 700 extends from the heel 712 into the aquifer 704 for a horizontal withdrawal well distance D_{ww} until the horizontal portion 714 reaches a well toe 716. In an example, the horizontal well distance D_{ww} that the withdrawal well 700 extends into the aquifer 704, e.g., from the aquifer boundary 706 to the toe 716, is from about 300 m (about 1000 ft) to about 3200 m (about 10,500 ft), such as from about 500 m (about 1600 ft) to about 1600 m (about 5300 ft).

The withdrawal well 700 can have one or more withdrawal well openings through which the brine 702 can pass into the withdrawal well 700. In an example, the one or more withdrawal well openings can comprise a plurality of perforations 718 in the tubing that forms the horizontal portion 714 of the horizontal withdrawal well 700. The perforations 718 are configured such that brine can be withdrawn from the aquifer 704 into the tubing of the withdrawal well 700 through the perforations 718 at several locations at the same time, as shown in the example of FIG. 7, where the brine 702 can then be brought to the surface via the withdrawal well 700. In an example, the perforations 718 are spaced evenly or substantially evenly along the surface of the horizontal portion 714.

In addition, the use of a deviated or highly deviated withdrawal well allows the operator more freedom to reduce the pressure differential across the one or more withdrawal well openings (e.g., the perforations 718) in order to avoid sand production while still being able to maintain a relatively high brine withdrawal rate, which can provide for enhanced injectivity for the CO₂ being injected into the aquifer 704.

As described above with respect to deviated or highly deviated CO₂ injection wells, the flow rate capacity for a deviated or highly deviated well can be as high as four times greater, or more, than a comparable vertical well for a given bottom hole pressure. Therefore, a single deviated or highly deviated withdrawal well can provide the same pressure management and brine withdrawal capability as many more vertical wells. The use of one or more deviated or highly deviated wells can have similar financial benefits to those described above with respect to deviated or highly deviated injection wells. For example, a single deviated or highly deviated withdrawal well with a well length D_{WW} of 2000 feet (about 600 m) is estimated to cost about $8,000,000 to drill and complete the well. This deviated or highly deviated well has the same brine withdrawal capacity as four (4) vertical wells, which are each estimated to cost about $5,000,000 for a total of $20,000,000. Therefore, using a single deviated or highly deviated withdrawal well provides for the same brine withdrawal capacity and the same pressure management capability for the CO₂ injection at a cost savings of about $12 million ($8 million versus $20 million), or a capital cost savings of about 60%.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
introducing a sequestration fluid through one or more injection wells into an underground reservoir containing at least one native fluid, wherein each of the one or more injection wells includes one or more injection well reservoir openings through which the sequestration fluid flows from the injection well into the underground reservoir; and
simultaneously or substantially simultaneously withdrawing a portion of the at least one native fluid through one or more withdrawal wells, wherein each of the one or more injection wells includes one or more withdrawal well reservoir openings through which the portion of the at least one native fluid flows from the underground reservoir into the withdrawal well, wherein the one or more withdrawal well reservoir openings are proximate to the one or more injection well reservoir openings.

2. A method according to claim 1, wherein the one or more withdrawal well reservoir openings are located within a specified distance from the one or more injection well reservoir openings.

3. A method according to claim 2, wherein the specified distance is from about 30 meters to about 3000 meters.

4. A method according to claim 1, wherein the at least one native fluid comprises brine.

5. A method according to claim 1, wherein the sequestration fluid comprises carbon dioxide.

6. A method according to claim 1, wherein at least one of the one or more withdrawal wells is a deviated or highly deviated withdrawal well.

7. A method according to claim 1, wherein at least one of the one or more injection wells is a deviated or highly deviated injection well.

8. A method according to claim 1, further comprising producing a production fluid comprising a portion of the sequestration fluid through one or more production wells and converting thermal energy in the production fluid to electricity, heat energy, or a combination thereof.

9. A system comprising:
one or more injection wells for accessing an underground reservoir, the reservoir containing at least one native fluid, each of the one or more injection wells having one or more injection well reservoir openings in fluid communication with the underground reservoir;
a sequestration fluid supply system for providing a sequestration fluid to the one or more injection wells;
wherein the one or more injection wells and the sequestration fluid supply system are configured to inject the sequestration fluid into the underground reservoir through the one or more injection well reservoir openings; and
one or more withdrawal wells each having one or more withdrawal well reservoir openings in fluid communication with the underground reservoir, wherein the one or more withdrawal well reservoir openings are proximate to the one or more injection well reservoir openings;
wherein the one or more withdrawal wells are configured to withdraw a portion of the at least one native fluid simultaneously or substantially simultaneously with injection of the sequestration fluid into the underground reservoir.

10. A system according to claim 9, wherein the one or more withdrawal well reservoir openings are located within a specified distance from the one or more injection well reservoir openings.

11. A system according to claim 10, wherein the specified distance is from about 30 meters to about 3000 meters.

12. A system according to claim 9, wherein the native fluid comprises brine.

13. A system according to claim 9, wherein the sequestration fluid comprises carbon dioxide.

14. A system according to claim 13, wherein the carbon dioxide is supercritical carbon dioxide.

15. A system according to claim 9, wherein the one or more injection well reservoir openings of each of the one or more injection wells comprises a plurality of perforations in the injection well.

16. A system according to claim 9, wherein the one or more withdrawal well reservoir openings of each of the one or more withdrawal wells comprises a plurality of perforations in the withdrawal well.

17. A system according to claim 9, further comprising one or more production wells, each having one or more production well reservoir openings in fluid communication with the underground reservoir, wherein a production fluid comprising a portion of the sequestration fluid is produced through the one or more production wells.

18. A system according to claim 17, wherein exposure of the production fluid to the underground reservoir heats the production fluid, the system further comprising an energy recovery system configured to convert thermal energy in the production fluid to electricity, heat energy, or a combination thereof.

19. A system according to claim 9, wherein at least one of the one or more withdrawal wells is a deviated or highly deviated withdrawal well.

20. A system according to claim 9, wherein at least one of the one or more injection wells is a deviated or highly deviated injection well.
